(19) United States
(12) Patent Application Publication
(10) Pub. No.: US 2013/0236800 A1
(43) Pub. Date: Sep. 12, 2013

(54) METHOD OF ACTIVATING FUEL CELL

(71) Applicant: SAMSUNG ELECTRONICS CO., LTD., Suwon-si (KR)

(72) Inventors: Tae-won SONG, Yongin-si (KR); Ji-rae KIM, Seoul (KR); Jung-seok YI, Seoul (KR); Jeong-sik KO, Seongnam-si (KR)

(73) Assignee: SAMSUNG ELECTRONICS CO., LTD., Suwon-si (KR)

(21) Appl. No.: 13/788,298

(22) Filed: Mar. 7, 2013

(30) Foreign Application Priority Data
Mar. 7, 2012 (KR) 10-2012-0023603

(51) Int. Cl. H01M 8/04

(52) U.S. Cl. CPC H01M 8/04223
USPC 429/415; 429/429; 429/423

(57) ABSTRACT

A method of activating a fuel cell includes: supplying a fuel to an anode of the fuel cell; supplying a gas mixture to a cathode of the fuel cell; applying a second load, which is equal to or less than a predetermined first load, to a stack of the fuel cell after supplying the gas mixture to the cathode; discontinuing the supply of the gas mixture; resupplying the gas mixture to the cathode when a voltage of the stack of the fuel cell is a predetermined voltage or less after discontinuing the supply of the gas mixture; and applying a third load, which is higher than the predetermined first load, to the stack of the fuel cell, where the supply of the fuel to the anode of the fuel cell is maintained.

### CROSS-REFERENCE TO RELATED APPLICATIONS

This application claims priority to Korean Patent Application No. 10-2012-0023603, filed on Mar. 7, 2012, and all the benefits accruing therefrom under 35 U.S.C. §119, the content of which is in its entirety is herein incorporated by reference.

### BACKGROUND

1. Field

The disclosure relates to a fuel cell, and more particularly, to a method of activating a fuel cell.

2. Description of the Related Art

After manufacturing a stack of a fuel cell, an activation process may be performed to stably secure a maximum output thereof.

The activation process may be performed in the early stage of an operation of the fuel cell. The activation process activates a catalyst that has not participated in an electrochemical reaction in the stack, and secures the distribution of a conductor (for example, water or phosphoric acid) in an electrolyte included in an electrolyte membrane and electrode.

In general, a fuel cell is activated by repeatedly performing a load operation and an open circuit voltage (“OCV”) operation.

In a conventional OCV operation or low load operation, a cell voltage may be about 0.8 volt (V) or greater. In the conventional OCV operation and low load operation, a cathode catalyst is exposed to an oxidation environment during the OCV operation and is exposed to a reduction environment during the load operation. The deterioration of the cathode catalyst may occur due to the repetition of such oxidation-reduction such that the durability of a stack of the fuel cell may be substantially weakened, and a long time may be required for the activation process.

### SUMMARY

Provided are methods of activating fuel cells, in which an activation may be performed in an environment of about 0.8 volt (V) or less.

Additional features will be set forth in part in the description which follows and, in part, will be apparent from the description, or may be learned by practice of the presented embodiments.

According to an embodiment of the invention, a method of activating a fuel cell includes: supplying a fuel to an anode of the fuel cell; supplying a gas mixture to a cathode of the fuel cell; applying a second load, which is equal to or less than a predetermined first load, to a stack of the fuel cell after supplying the gas mixture to the cathode; discontinuing the supply of the gas mixture; resupplying the gas mixture to the cathode when a voltage of the stack of the fuel cell is a predetermined voltage or less after discontinuing the supply of the gas mixture; and applying a third load, which is higher than the predetermined first load, to the stack of the fuel cell, where the supply of the fuel to the anode of the fuel cell is maintained.

In an embodiment, the method may further include before the applying the third load to the stack of the fuel cell, repeating the discontinuing the supply of the gas mixture and the resupplying of the gas mixture to the cathode, before the applying the third load to the stack.

In an embodiment, the method may further include supplying only air to the cathode after the applying the third load to the stack of the fuel cell.

In an embodiment, the method may further include after the applying the load to the stack of the fuel cell, repeating the applying the second load to the stack of the fuel cell, the discontinuing the supply of the gas mixture, the resupplying the gas mixture to the cathode when the voltage of the stack is the predetermined voltage or less after the discontinuing the supply of the gas mixture, and the applying the third load to the stack.

In an embodiment, the gas mixture may include air and a fuel gas.

In an embodiment, the predetermined first load may be about 25 percent or less of a rated load of the stack of the fuel cell.

In an embodiment, the fuel gas may be supplied from the anode or a fuel reformer.

In an embodiment, the discontinuation of the supply of the gas mixture may include applying a pressurized air to the cathode.

In an embodiment, the gas mixture may be resupplied to the cathode when the voltage of the stack of the fuel call is in a range of about 0.1 volt (V) to about 0.4 V.

In an embodiment, the air and the fuel gas in the gas mixture may maintain a ratio in which an open circuit voltage of the stack of the fuel cell is 0.8 V or less.

In embodiments of a method of activating a fuel cell according to the invention, a gas mixture including air and a fuel is periodically or aperiodically supplied to a cathode of the fuel cell once or more, and a low-load state is maintained by applying a low load to the stack of the fuel cell while the gas mixture is supplied to the cathode or a load higher than the low load is applied for a predetermined time during the low-load state. According to embodiments of the method, a cell voltage may be maintained to be about 0.8 V or less during the activation of the fuel cell. In such embodiments, the deterioration of a cathode catalyst is effectively prevented during the activation of the fuel cell, and the durability of the fuel cell is thereby substantially improved.

### BRIEF DESCRIPTION OF THE DRAWINGS

These and/or other features of the invention will become apparent and more readily appreciated from the following description of embodiments thereof, taken in conjunction with the accompanying drawings, in which:

FIG. 1 is a flowchart illustrating an embodiment of a method of activating a fuel cell according to the invention;

FIG. 2 is a timing diagram showing operations according to time in an embodiment of the method of activating a fuel cell of FIG. 1;

FIG. 3 is a flowchart illustrating an alternative embodiment of a method of activating a fuel cell according to the invention;

FIG. 4 is a timing diagram showing operations according to time in an embodiment of the method of activating a fuel cell of FIG. 3; and

FIG. 5 is a graph illustrating cell voltage of a stack versus operating time in an embodiment of a method of activating a fuel cell according to the invention.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, embodiments of a method of activating a fuel cell will be described in detail with reference to the drawings, in which thicknesses of layers and regions are enlarged for clarity.

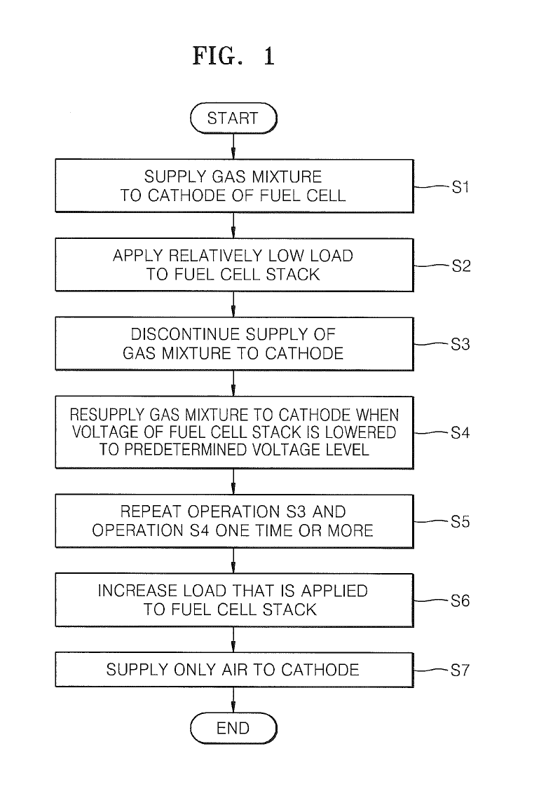

FIG. 1 is a flowchart illustrating an embodiment of a method of activating a fuel cell according to the invention.

Referring to FIG. 1, in an embodiment, a gas mixture is supplied to a cathode of a fuel cell (operation S1). In such an embodiment, the gas mixture may be a mixture of a fuel gas and air. In such an embodiment, the fuel gas may be a hydrogen (H₂) gas or a reformatted gas, for example. In an embodiment, the fuel gas is the hydrogen (H₂) gas, and the mixing ratio of air to the fuel gas in the gas mixture is a ratio of air with respect to hydrogen (H₂), in which an open circuit voltage (“OCV”) of the fuel cell is about 0.8 volt (V) or less. The fuel gas included in the gas mixture, which is supplied to the cathode (also referred to as an air electrode), may be supplied from an anode (also referred to as a fuel electrode). In an embodiment, the fuel gas may be supplied from an inlet of the anode (e.g., an outlet of a fuel reformer) or an outlet of the anode to the cathode.

After the gas mixture is supplied to the cathode, a relatively low load is applied to a fuel cell stack, that is, a stack of the fuel cell (operation S2). In such an embodiment, the load applied to the stack of the fuel cell may be lowered from a first load to a second load, which is lower than the first load, after the gas mixture is supplied to the cathode. The relatively low load, e.g., the second load, may be a load that consumes a current having a current density of about 0.01 ampere per square centimeter (A/cm²). In such an embodiment, the first load may be about 25 percent or less of a rated load of the stack of the fuel cell.

Subsequently, the supply of the gas mixture to the cathode is discontinued after the relatively low load is applied (operation S3). In an embodiment, the supply of the gas mixture may be discontinued by applying a pressurized air to the cathode (the air electrode). In an alternative embodiment, the supply of the gas mixture may be discontinued in a state where an internal pressure is maintained higher than a predetermined pressure, e.g., atmospheric pressure, by adjusting an outlet pressure of the cathode. In such an embodiment, oxygen remaining in a channel reacts to the load applied to the stack, e.g., the second load, and the distribution of phosphoric acid in a catalyst layer is substantially improved due to water generated by an electrochemical reaction in the fuel cell. In such an embodiment, oxygen may be transmitted by diffusion in the catalyst layer, and a reaction in an unreacted region substantially increases due to the discontinuation of the supply of the gas mixture. In such an embodiment, a reaction region may be expanded substantially in the direction of a fuel gas supply layer, which is disposed adjacent to a membrane. In such an embodiment, evaporation from the flow of the water generated by the electrochemical reaction may be substantially reduced when the gas mixture is not supplied. Accordingly, in such an embodiment, the distribution of phosphoric acid in a catalyst layer is substantially improved, and a membrane electrode assembly (“MEA”) and the stack of the fuel cell are thereby effectively activated.

Next, the voltage of the stack of the fuel cell is measured, and the gas mixture is supplied to the cathode again when the voltage of the stack is lowered to a predetermined voltage (operation S4). In one embodiment, the predetermined voltage may be, for example, in a range of about 0.1 V to about 0.4 V. Next, when the activation of the fuel cell is not sufficient, operation S3 and operation S4 are repeated, repeated once or more (operation S5). In an embodiment, operation S3 and operation S4 may be repeated until the voltage of the stack of the fuel cell reaches a predetermined level. In an alternative embodiment, operation S3 and operation S4 may be repeated a predetermined number of times. Next, the load applied to the stack is increased (operation S6) to a higher load, e.g., a third load. In such an embodiment, the third load applied to the stack in operation S6 is higher than the relatively low load, e.g., the second load. In one embodiment, for example, the third load applied to the stack in operation S6, e.g., the third load, may be a load that is about 25 percent or greater of the rated load of the stack of the fuel cell. When the relatively low load, e.g., the second load, is about 25 percent or less of the rated load, the load that is applied to the stack in operation S6, e.g., the third load, may be a load that is greater than about 25 percent of the rated load. After operation S6, only air is supplied to the cathode (operation S7). In operation S6, the fuel gas is not supplied to the cathode. After operation S7, the activation operation of the fuel cell is terminated, and a normal operation, where the rated load is applied, is performed. In such an embodiment, the fuel gas is continuously applied to the anode while operations S1 through S7 are performed.

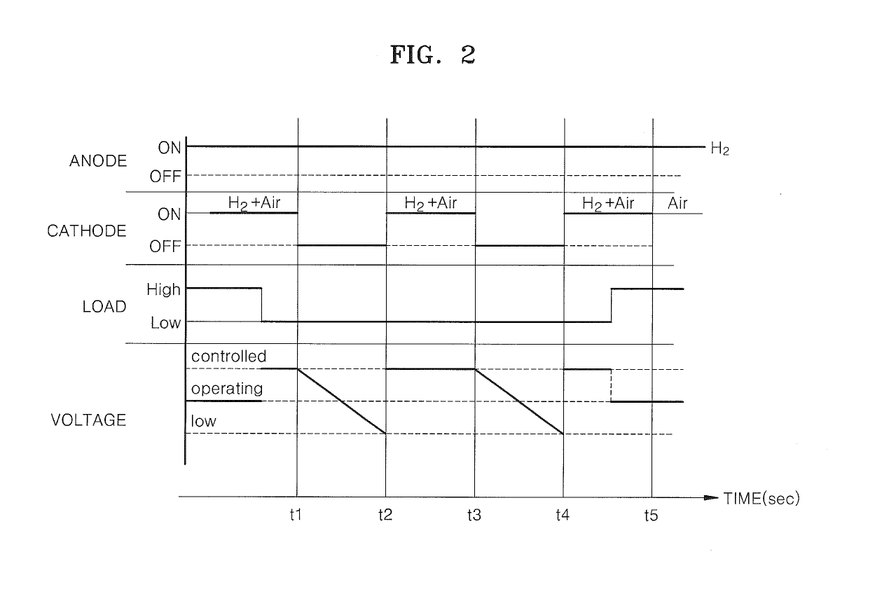

FIG. 2 is a timing diagram showing operations according to time in an embodiment of the method of activating a fuel cell of FIG. 1.

Referring to FIG. 2, the fuel gas (H₂) is continuously supplied to the anode (the fuel electrode) until an activation process is completed. After the gas mixture (e.g., H₂+Air) is supplied to the cathode (the air electrode), the relatively low load, e.g., the second load, is applied to the stack. In an embodiment, the load applied to the stack may be directly changed from a relatively high load (e.g., the first load, which may be 25 percent or greater of the rated load) to the relatively low load (e.g., the second load). In an alternative embodiment, the load applied to the stack of the fuel cell may be changed from the relatively high load to a zero load, and then may be increased from the zero load to the relatively low load. In such an embodiment, the zero load applied to the stack means a state where no load is applied to the stack. When the load applied to the stack is changed from the relatively high load to the relatively low load (e.g., from the first load to the second load), the voltage of the stack is changed from an operating voltage, which is a voltage when the relatively high load is applied to the stack, to a controlled voltage. The controlled voltage is a voltage of the stack, which is generated when the gas mixture is supplied to the cathode and the relatively low load is applied to the stack. In one embodiment, the controlled voltage may be about 0.8 V or less, for example.

After the gas mixture is supplied to the cathode until a first point in time t1, the supply of the gas mixture is discontinued from the first point in time t1 to a second point in time t2. When the supply of the gas mixture is discontinued, the load applied to the stack is maintained as the relatively low load, e.g., the second load. Accordingly, the voltage of the stack is gradually lowered to a predetermined low voltage from the first point in time t1 to the second point in time t2. In one embodiment, the predetermined low voltage may be, for example, in a range of about 0.1 V to about 0.4 V. In such an embodiment, the second point in time t2 may be a point in time when the voltage of the stack is lowered to the predetermined low voltage after the first point in time t1. The supply and discontinuation of the gas mixture to the cathode may be repeated from the second point in time t2 to a fifth point in time t5. During the repetition of the supply and discontinuation of the gas mixture to the cathode, the load applied to the stack is maintained as the relatively low load, e.g., the second load. After a fourth point in time t4, the gas mixture is supplied to the cathode again, and then the high load (e.g., the third load), which is higher than the relatively low load, is applied to the stack. In such an embodiment, during the repetition of the supply and discontinuation of the gas mixture to the cathode, a process, in which the voltage of the stack is increased to the controlled voltage and is decreased to the low voltage, is repeated. The voltage of the stack becomes the controlled voltage after the fourth point in time t4, and becomes the operating voltage when the load of the stack is changed from the relatively low load (e.g., the second load) to the relatively high load (e.g., the third load). After the fifth point in time t5, only air is supplied to the cathode and the fuel gas is not supplied to the cathode. In such an embodiment, after the fifth point in time t5, the activation operation of the stack is terminated and the normal operation thereof is performed. In FIG. 2, before the process from the fourth point in time t4 to the fifth point in time t5 is performed, the process from the second point in time t2 to the fourth point in time t4 may be repeatedly performed once or more.

The following table 1 shows processes in an embodiment of the method of activating a fuel cell, illustrated in FIG. 1 or FIG. 2.

TABLE 1

| | | Load | | | | | | | | |
|---|---|---|---|---|---|---|---|---|---|---|
| | | High | High→Low | Low | Low | Low | ... | Low | Low→High | High |
| Gas | Anode | H₂ | H₂ | H₂ | H₂ | H₂ | ... | H₂ | H₂ | H₂ |
| supply | Cathode | Air | Air + H₂ | — | Air + H₂ | — | ... | Air + H₂ | Air + H₂ | Air |

| | | | | | | | | | |
|---|---|---|---|---|---|---|---|---|---|
| Voltage | Operating | Controlled | ↓ | Controlled | ↓ | ... | Controlled | Operating | Operating |

In Table 1,
“High→Low” or “Low→High” indicates that the load applied to the fuel cell is changed from the relatively high load to the relatively low load, or from the relatively low load to the relatively high load,
“H₂” indicates the supply of the hydrogen fuel gas,
“Air” indicates the supply of air, and
“Air + H₂” indicates the supply of the gas mixture.
“—” indicates the discontinuation of the supply of the gas mixture.
“Operating” indicates the voltage of the stack when the hydrogen gas (H₂) and air (Air) are supplied to the anode and the cathode, respectively, in a state where the relatively high load is applied to the fuel cell.
“Controlled” indicates the voltage of the stack when the hydrogen gas (H₂) and the gas mixture are supplied to the anode and the cathode, respectively, in a state where the relatively low load is applied to the fuel cell.
The symbol “↓” indicates that the voltage of the stack is lowered.

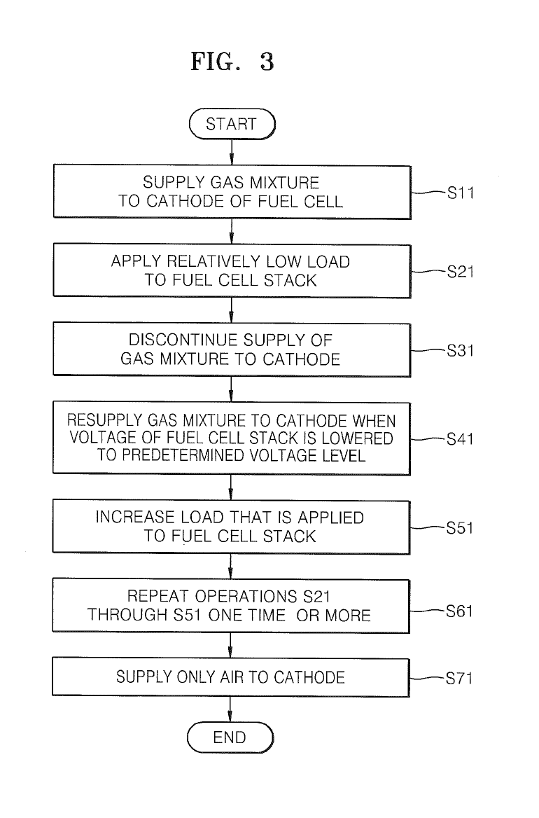

FIG. 3 is a flowchart illustrating an alternative embodiment of a method of activating a fuel cell according to the invention.

Operations S11 through S41 in an embodiment shown in FIG. 3 are substantially the same as operations S1 through S4 of the embodiment shown in FIG. 1. In an embodiment, as shown in FIG. 3, after performing operation S41, the load applied to a stack of the fuel cell is increased (operation S51). The load applied to the stack in operation S51 may be increased to 25 percent or greater of the rated load. Operation S51 of FIG. 3 is substantially the same as operation S6 of FIG. 1. After operation S51, operations S21 through S51 may be repeated once or more when the activation of the fuel cell is not sufficient. After operation S61, only air is supplied to the cathode (operation S71). In such an embodiment, after operation S61, the activation operation of the fuel cell is terminated and the normal operation is performed. In the embodiment of FIG. 3, the fuel gas is supplied to the anode during all operations S11 to S71.

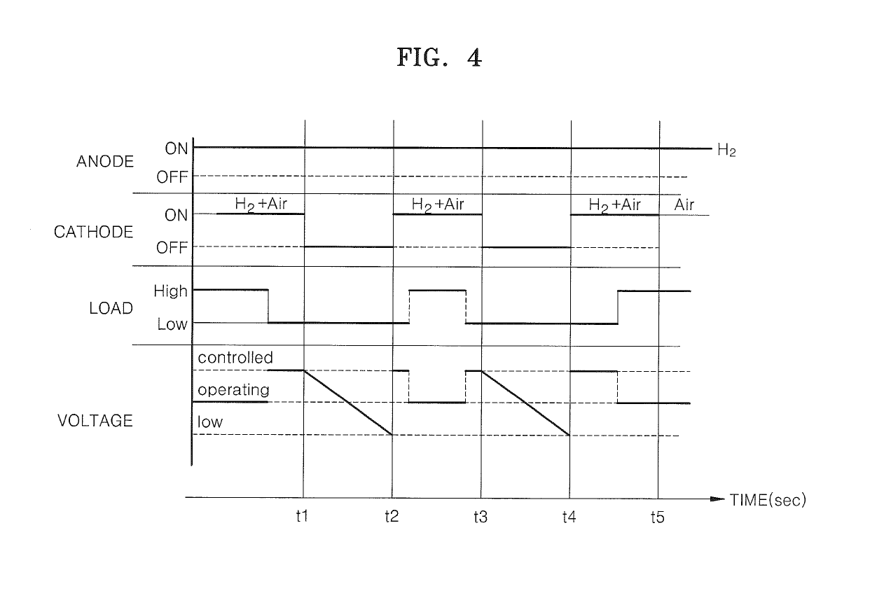

FIG. 4 is a timing diagram showing operations according to time in an embodiment of the method of activating a fuel cell according to the invention.

The gas supply to the anode and cathode in each time period in the embodiment shown in FIG. 4 is substantially the same as in the embodiment shown in FIG. 2. In an embodiment, as shown in FIG. 4, during the time period from the second point in time t2 and the third pint in time t3 when the gas mixture is supplied to the cathode again, the load applied to the stack is changed from the relatively low load to the relatively high load and is changed from the relatively high load to the relatively low load. In one embodiment, for example, the load applied to the stack is changed from the relatively low load to the relatively high load after a predetermined time period from the second point in time t2 and is changed from the relatively high load to the relatively low load at before a predetermined time from the third point in time t3. According to the change of the load applied to the stack, the voltage of the stack, which is the controlled voltage initially after the second point in time t2, is lowered to the operating voltage when the load is changed from the relatively low load to the relatively high load, and changed from the operating voltage to the controlled voltage when the load is changed from the relatively high load to the relatively low load again, and maintained as the controlled voltage until the third point in time t3. In time periods other than the time period between the second point in time t2 and the third point in time t3, the voltage of the stack may be substantially the same as the voltage of the stack in the embodiment shown in FIG. 2. In FIG. 4, processes from a point in time when the load is changed from the relatively high load to the relatively low load before the first point in time t1 to a point in time when the load is changed from the relatively high load to the relatively low load between the second point in time t2 and the third point in time t3 may be repeated once or more.

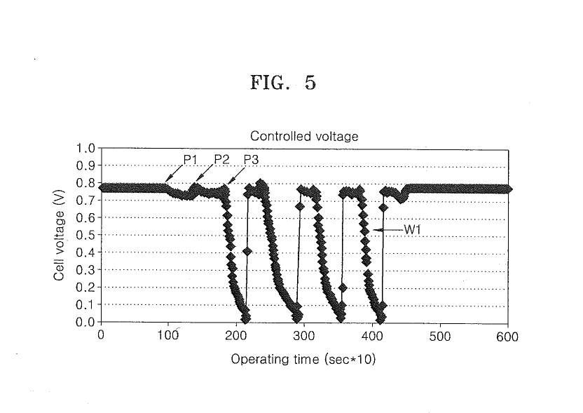

FIG. 5 is a graph illustrating change of a cell voltage of the stack, according to operating time in an embodiment of a method of activating a fuel cell according to the invention.

Referring to FIG. 5, the cell voltage of the stack is controlled to be about 0.8 V or less during the activation of the fuel cell. In FIG. 5, a first point P1 indicates a point in time when the gas mixture (Air+H₂) is supplied to the cathode. At a second point P2, a current density of the stack is lowered from about 0.05 A/cm² to about 0.01 A/cm². A third point P3 indicates a point in time when the supply of the gas mixture is discontinued. In FIG. 5, a start point of the ridge of each undulation W1 is a point in time when the gas mixture (Air+H₂) is supplied, and an end point of the ridge of each undulation W1 is a point in time when the supply of the gas mixture is discontinued.

It should be understood that the embodiments described herein should be considered in a descriptive sense only and not for purposes of limitation. Descriptions of features within each embodiment should typically be considered as available for other similar features in other embodiments.

What is claimed is:

1. A method of activating a fuel cell, the method comprising:
supplying a fuel to an anode of the fuel cell;
supplying a gas mixture to a cathode of the fuel cell;
applying a second load, which is equal to or less than a predetermined first load, to a stack of the fuel cell after supplying the gas mixture to the cathode;
discontinuing the supply of the gas mixture;
resupplying the gas mixture to the cathode when a voltage of the stack of the fuel cell is a predetermined voltage or less after the discontinuing the supply of the gas mixture; and
applying a third load, which is higher than the predetermined first load, to the stack of the fuel cell,
wherein the supply of the fuel to the anode of the fuel cell is maintained.

2. The method of claim 1, further comprising:
before the applying the third load to the stack of the fuel cell, repeating the discontinuing the supply of the gas mixture and the resupplying of the gas mixture to the cathode.

3. The method of claim 1, further comprising:
supplying only air to the cathode after the applying the third load to the stack of the fuel cell.

4. The method of claim 1, further comprising:
after the applying the third load to the stack of the fuel cell, repeating the applying the second load to the stack of the fuel cell, the discontinuing the supply of the gas mixture, the resupplying the gas mixture to the cathode when the voltage of the stack of the fuel cell is the predetermined voltage or less after the discontinuing the supply of the gas mixture, and the applying the third load to the stack of the fuel cell.

5. The method of claim 1, wherein the gas mixture comprises air and a fuel gas.

6. The method of claim 1, wherein the predetermined first load is about 25 percent or less of a rated load of the stack of the fuel cell.

7. The method of claim 5, wherein the fuel gas is supplied from the anode or a fuel reformer.

8. The method of claim 1, wherein the discontinuing the supply of the gas mixture comprises applying a pressurized air to the cathode.

9. The method of claim 1, wherein the gas mixture is resupplied to the cathode when the voltage of the stack of the fuel cell is in a range of about 0.1 volt to about 0.4 volt.

10. The method of claim 5, wherein the air and the fuel gas in the gas mixture maintain a ratio in which an open circuit voltage of the stack of the fuel cell is about 0.8 volt or less.

11. The method of claim 2, wherein the discontinuing the supply of the gas mixture comprises applying a pressurized air to the cathode.

12. The method of claim 2, wherein the gas mixture is resupplied to the cathode when the voltage of the stack of the fuel cell is in a range of about 0.1 volt to about 0.4 volt.

13. The method of claim 4, wherein the discontinuing the supply of the gas mixture comprises applying a pressurized air to the cathode.

14. The method of claim 4, wherein the gas mixture is resupplied to the cathode when the voltage of the stack of the fuel cell is in a range of about 0.1 volt to about 0.4 volt.

15. The method of claim 1, wherein the discontinuing the supply of the gas mixture comprises discontinuing the supply of the gas mixture in a state where an internal pressure is maintained higher than an atmospheric pressure by adjusting an outlet pressure of the cathode.

16. The method of claim 2, wherein the discontinuing the supply of the gas mixture comprises discontinuing the supply of the gas mixture in a state where an internal pressure is maintained higher level than an atmospheric pressure by adjusting an outlet pressure of the cathode.

17. The method of claim 4, wherein the discontinuing the supply of the gas mixture comprises discontinuing the supply of the gas mixture in a state where an internal pressure is maintained higher level than an atmospheric pressure by adjusting an outlet pressure of the cathode.
